(19) United States
(12) Patent Application Publication
(10) Pub. No.: US 2017/0208756 A1
(43) Pub. Date: Jul. 27, 2017

(54) WATER STORAGE AND DISPENSING SYSTEM

(71) Applicant: Troels Broebech Mikkelsen, Skaelskoer (DK)

(72) Inventor: Troels Broebech Mikkelsen, Skaelskoer (DK)

(21) Appl. No.: 15/412,008

(22) Filed: Jan. 21, 2017

Related U.S. Application Data
(60) Provisional application No. 62/281,231, filed on Jan. 21, 2016.

(51) Int. Cl. A01G 25/16; A01G 27/04; B05B 9/03; A01G 25/02; F16M 13/06; F16M 11/24; A01C 21/00; A01G 27/00

(52) U.S. Cl. CPC A01G 25/165; A01C 21/005; A01G 27/04; A01G 27/003; A01G 25/02; F16M 13/06; F16M 11/24; B05B 9/03

(57) ABSTRACT

A water storage and dispensing system comprising a post, a water source and a plant watering system. The primary function of the post is to act as a support structure for a variety of devices, which may include, but are not limited to, mail boxes, street lights, fence and signboards. The post has a hollow interior, and also has an inlet means and an outlet means. The water source is connected to the inlet means to fill water in the hollow interior of the post. The plant watering system is connected to the outlet means to use water dispensed by the post for watering plants surrounding the post.

### PRIORITY CLAIM

The present application claims priority to U.S. Provisional Patent Application Ser. No. 62/281,231, filed Jan. 21, 2016, the complete text of which is included by reference herein.

### FIELD OF THE INVENTION

The present invention relates generally to multi-purpose use of posts or poles. The present invention is more particularly directed to use of posts or poles as containers for storing and dispensing water in addition to regular use of providing support to structures.

### BACKGROUND OF THE INVENTION

Posts or poles have a ubiquitous presence around us, be in form of poles for street lighting and fences, or posts for mail boxes and signs. However, these posts/poles act only as a support structure and do not serve any other purpose.

The present invention provides such a system where these posts or poles could be utilized more efficiently by putting to additional use of storing and dispensing water, while performing the regular function of providing support to various structures (street lighting, part of a fence, mail box, signs, etc.). The dispensed water can be channeled through a watering system of a user's choice to water the plants surrounding the posts or poles. As a result, the user may not to have to be out every day to water his plants to ensure that the plants do not dry out.

### SUMMARY OF THE INVENTION

This section provides the various objectives which the present invention aims to achieve, along with a brief summary of the present invention.

An objective of the present invention is to use a post or pole as a container for storing water.

Another objective of the present invention is to use a post or pole for dispensing water to an area surrounding the post or pole.

To fulfill these objectives and more, the present invention provides a water storage and dispensing system comprising a post or pole, wherein the post or pole is hollow. Water can be stored inside the hollow post or pole by using an inlet means attached to a water pipe. Water can be dispensed from the hollow post or pole using an outlet means. The outlet means could be attached to a watering system of user's choice to water the plants in an area surrounding the post or pole.

All of the advantages and features of the present invention are set forth in the description which follows, and will become apparent to those ordinarily skilled in the art upon examination of the following, or may be learned by practice of the invention. These advantages and features of the present invention will be more readily apparent when considered in reference to the following description and when taken in conjunction with the drawings accompanying this specification.

### DESCRIPTION OF THE DRAWINGS

FIG. 1 is a side view of water storage and dispensing system, as per an exemplary non-limiting embodiment of the present invention.

### DESCRIPTION OF THE INVENTION

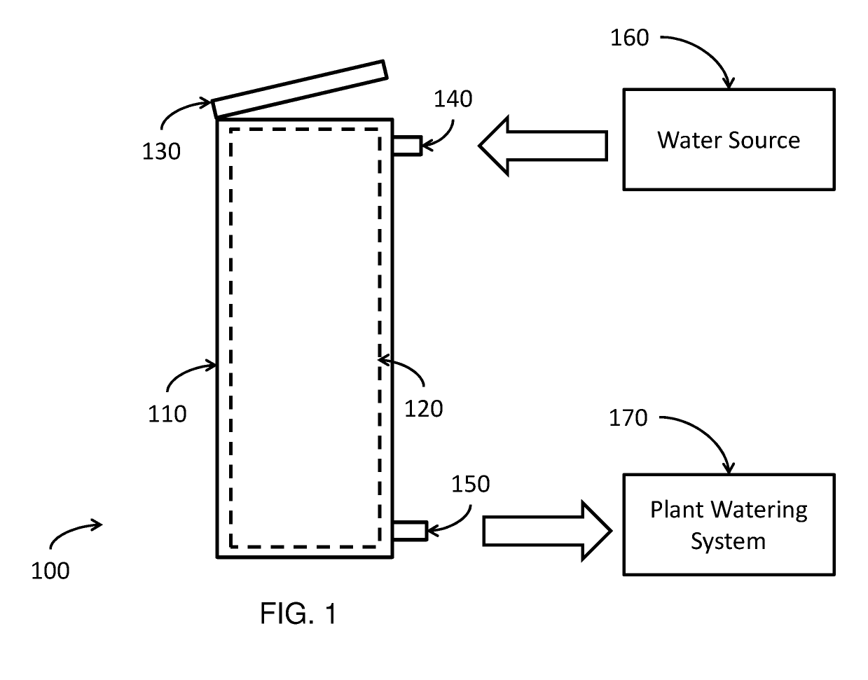

A water storage and dispensing system 100 as per the present invention has been explained henceforth using exemplary non-limiting embodiments of the present invention with reference to the accompanied drawing, FIG. 1.

As per an exemplary non-limiting embodiment of the present invention, the water storage and dispensing system 100 comprises a post or pole 110, hereinafter collectively referred as a post 110. The post 110 comprises a hollow interior 120, as shown in the FIG. 1. As will be apparent to the person of ordinary skills in the art, the post 110 and the hollow interior 120 may have varying shapes and dimensions. The hollow interior 120 of the post may have a waterproof surface. Further, the post 110 may act as a support structure for a mail box as a primary function of the post. In various embodiments of the present invention, the post 110 may act as a support structure for a variety of devices, which may include, but are not limited to, street lights, fence and signboards.

The post 110 further comprises at least one inlet means 140, as shown in the FIG. 1. The at least one inlet means 140 would allow water to be filled inside the hollow interior 120 of the post 110 by connecting to a water carrying device or water source 160, which may include, but is not limited to, a hose connected to a running water source or a watering can (not shown in the FIG. 1). The at least one inlet means 140 would be located preferably in a top section of the post 110, as shown in the FIG. 1. However, as per another embodiment of the present invention, the inlet means 140 could be located in a bottom section of the post 110 as well.

As per yet another embodiment of the present invention, the hollow interior 120 of the post could also be accessed by lifting up a top cap section 130 of the post 110, as shown in the FIG. 1. Thereafter water can be directly poured inside the hollow interior of the post using a water carrying device or water source 160, which may include, but is not limited to, a hose or a watering can.

The post 110 further comprises at least one outlet means 150, as shown in the FIG. 1. The at least one outlet means 150 would allow water to be dispensed from the hollow interior 120 of the post 110. The at least one outlet means 150 would be located preferably in a bottom section of the post 110, as shown in the FIG. 1. The outlet means 150 may include a control mechanism to control dispensing of water as needed by the user.

The at least one outlet means 150 would be connected to a plant watering system 170 of a user's choice which would allow watering the plants in an area surrounding the post 110. Examples of the plant watering system 170 may include, but are not limited to, a wick watering system and a drip watering system. The water source 160 may further comprise fertilizers so that the plants can be fertilized during watering.

As can be understood from the description above, the invention permits a user to conveniently water the plants surrounding one of its posts 110 by using the existing structures itself. Also, if the inlet means 140 could always be directly connected to a running water source 160, for example using a tap and a hosepipe, then the user could fill the hollow interior 120 of the post 110 without approaching the post 110. As per an embodiment of the present invention, if the inlet means 140 could be connected to a first timer, the hollow interior 120 of the post 110 could be filled with water from the running water source 160 at scheduled times, as defined by the user, using the first timer.

In a similar manner, if the plant watering system 170 connected to the outlet means 150 of the post 110 could be attached to a second timer, water can be dispensed to the connected plant watering system 170 at scheduled times as defined by the user, using the second timer.

Various modifications to the above described invention will be readily apparent to those ordinarily skilled in the art and the general principles defined herein may be applied to other embodiments and applications without departing from the spirit and scope of the present invention. Thus, the present invention is not intended to be limited to the embodiments described, but is to be accorded the widest scope consistent with the principles and features disclosed herein.

Therefore, the scope of the invention is to be determined by the terminology of the above description and the legal equivalents thereof.

What is claimed is:

1. A water storage and dispensing system comprising:
a post, wherein the primary function of the post is to act as a support structure, and wherein the post has a hollow interior, and wherein the post has at least one inlet means and at least one outlet means;
a water source, wherein the water source is connected to the at least one inlet means to fill water in the hollow interior of the post; and
a plant watering system, wherein the plant watering system is connected to the at least one outlet means to use water dispensed by the post for watering plants surrounding the post.

2. The water storage and dispensing system of claim 1, wherein the at least one inlet means is located in a top section of the post.

3. The water storage and dispensing system of claim 1, wherein the at least one inlet means is located in a bottom section of the post.

4. The water storage and dispensing system of claim 1, wherein the at least one outlet means is located in a bottom section of the post.

5. The water storage and dispensing system of claim 1, wherein the hollow interior is waterproof.

6. The water storage and dispensing system of claim 1, further comprising a top cap section of the post, wherein the top cap section can be removed to fill water in the hollow interior of the post.

7. The water storage and dispensing system of claim 1, wherein the water source is a running water source, and wherein the running water source is always connected to the at least one inlet means.

8. The water storage and dispensing system of claim 7, further comprising a first timer connected to the inlet means, wherein the hollow interior of the post can be filled with water at scheduled times, as defined by a user, using the first timer.

9. The water storage and dispensing system of claim 1, further comprising a second timer connected to the outlet means, wherein the outlet means can dispense water to the plant watering system at scheduled times, as defined by a user, using the second timer.

10. The water storage and dispensing system of claim 1, wherein the water source may comprise fertilizers so that the plants can be fertilized during watering.

11. A water storage and dispensing system comprising:
a post, wherein the primary function of the post is to act as a support structure, and wherein the post has a hollow waterproof interior, and wherein the post has at least one inlet means and at least one outlet means, wherein the at least one outlet means is located in a bottom section of the post;
a water source, wherein the water source is connected to the at least one inlet means to fill water in the hollow interior of the post; and
a plant watering system, wherein the plant watering system is connected to the at least one outlet means to use water dispensed by the post for watering plants surrounding the post.

12. The water storage and dispensing system of claim 11, further comprising a top cap section of the post, wherein the top cap section can be removed to fill water in the hollow interior of the post.

13. The water storage and dispensing system of claim 11, wherein the water source is a running water source, and wherein the running water source is always connected to the at least one inlet means.

14. The water storage and dispensing system of claim 13, further comprising a first timer connected to the inlet means, wherein the hollow interior of the post can be filled with water at scheduled times, as defined by a user, using the first timer.

15. The water storage and dispensing system of claim 11, further comprising a second timer connected to the outlet means, wherein the outlet means can dispense water to the plant watering system at scheduled times, as defined by a user, using the second timer.

16. A water storage and dispensing system comprising:
a post, wherein the primary function of the post is to act as a support structure, and wherein the post has a hollow waterproof interior, and wherein the post has at least one inlet means and at least one outlet means, wherein the at least one outlet means is located in a bottom section of the post;
a running water source, wherein the running water source is connected to the at least one inlet means to fill water in the hollow interior of the post; and
a plant watering system, wherein the plant watering system is connected to the at least one outlet means to use water dispensed by the post for watering plants surrounding the post.

17. The water storage and dispensing system of claim 16, further comprising a first timer connected to the inlet means, wherein the hollow interior of the post can be filled with water at scheduled times, as defined by a user, using the first timer.

18. The water storage and dispensing system of claim 16, further comprising a second timer connected to the outlet means, wherein the outlet means can dispense water to the plant watering system at scheduled times, as defined by a user, using the second timer.
